(19) United States
(12) Patent Application Publication
(10) Pub. No.: US 2010/0141601 A1
(43) Pub. Date: Jun. 10, 2010

(54) TOUCH SCREEN DISPLAY APPARATUS AND METHOD OF OPERATING THE SAME

(75) Inventors: Eun-Ah Kim, Yongin-City (KR); Ki-Ju Im, Yongin-City (KR); Hye-Hyang Park, Yongin-City (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung Mobile Display Co., Ltd., Yongin-City (KR)

(21) Appl. No.: 12/634,442

(22) Filed: Dec. 9, 2009

(30) Foreign Application Priority Data
Dec. 10, 2008 (KR) 10-2008-0125323

(51) Int. Cl. G06F 3/041

(52) U.S. Cl. 345/173

(57) ABSTRACT

A touch screen display apparatus is disclosed. In one embodiment, the touch screen display apparatus includes: i) a plurality of light emitting devices disposed on a substrate, ii) at least one first light sensor, iii) at least one second light sensor, wherein the at least one first light sensor is less shielded from the light emitting devices than the at least one second light sensor and iv) a light detection controller configured to: i) detect the intensity of ambient illumination, ii) selectively operate one of 1) the at least one first light sensor and 2) the at least one second light sensor based at least in part on the detected intensity and iii) detect a touch location based at least in part on light detection by the selected sensor. According to one embodiment, light may be efficiently sensed, irrespective of the external light, since an additional internal sensor (first sensor) detects the light when the amount of the external light is insufficient.

### CROSS-REFERENCE TO RELATED PATENT APPLICATION

This application claims the benefit of Korean Patent Application No. 10-2008-0125323, filed on Dec. 10, 2008, in the Korean Intellectual Property Office, the disclosure of which is incorporated herein in its entirety by reference.

### BACKGROUND OF THE INVENTION

1. Field of the Invention

The present invention relates to a touch screen display apparatus and a method of operating the same, and more particularly, to a touch screen display apparatus for increasing touch recognition, irrespective of the intensity of an external light, and a method of operating the same.

2. Description of the Related Technology

Touch panels or touch screens are devices for inputting a command signal by touching a display screen with a finger or an instruction object such as a pen. A touch screen function is widely applied to flat panel display devices such as liquid crystal display (LCD) apparatuses and organic light emitting display (OLED) apparatuses.

### SUMMARY OF CERTAIN INVENTIVE ASPECTS

One aspect of the present invention is a touch screen display apparatus for reducing noise of internal light and increasing touch recognition, irrespective of the intensity of an external light and a method of operating the same.

Another aspect of the present invention is a touch screen display apparatus comprising: a light emitting unit comprising a plurality of light emitting devices disposed on a substrate; a first sensor unit comprising a plurality of light sensors that are disposed between the plurality of light emitting devices; a second sensor unit disposed between the plurality of light emitting devices, comprising a plurality of light sensors, and comprising a shading unit outside thereof so as to prevent a light from being incident from the plurality of light emitting devices; and a light detection controller, when external illumination is detected and the detected external illumination satisfies a predetermined condition, selecting one of the first sensor unit and the second sensor unit that is to be operated, and allowing the selected sensor unit to detect the light, and detecting a touch location.

The second sensor unit may detect the external illumination.

The light detection controller may comprise: an external illumination detecting unit detecting the external illumination; an operation sensor selecting unit, when the detected external illumination has a value satisfying the predetermined condition, selecting one of the first sensor unit and the second sensor unit that is to be operated; and a touch location detecting unit allowing the selected sensor unit to detect the light and detecting the touch location.

The touch screen display apparatus may further comprise: a third sensor unit comprised in a non-light emitting unit disposed outside the light emitting unit and comprising a plurality of light sensors.

The third sensor unit may detect the external illumination.

The second sensor unit and the third sensor unit may simultaneously detect the external illumination.

A plurality of the third sensor units may be disposed.

The first sensor unit and the second sensor unit may be alternately disposed.

The shading unit may be formed to surround the side surface of the second sensor unit.

The plurality of light emitting devices may be organic light emitting devices (OLEDs).

Another aspect of the present invention is a method of operating a touch screen display apparatus comprising a light emitting unit comprising a plurality of light emitting devices disposed on a substrate, a first sensor unit comprising a plurality of light sensors that are disposed between the plurality of light emitting devices; a second sensor unit disposed between the plurality of light emitting devices, comprising a plurality of light sensors, and comprising a shading unit outside thereof so as to prevent a light from being incident from the plurality of light emitting devices; and a third sensor unit comprised in a non-light emitting unit disposed outside the light emitting unit and comprising a plurality of light sensors, the method comprising: detecting external illumination; when the detected external illumination satisfies a predetermined condition, selecting one of the first sensor unit and the second sensor unit that is to be operated; and allowing the selected sensor unit to detect the light and detecting a touch location.

The second sensor unit may be used to detect the external illumination.

Another aspect of the present invention is a method of operating a touch screen display apparatus comprising a light emitting unit comprising a plurality of light emitting devices disposed on a substrate, a first sensor unit comprising a plurality of light sensors disposed between the plurality of light emitting devices; and a second sensor unit disposed between the plurality of light emitting devices, comprising a plurality of light sensors, and comprising a shading unit outside thereof so as to prevent a light from being incident from the plurality of light emitting devices, the method comprising: detecting external illumination; when the detected external illumination satisfies a predetermined condition, selecting one of the first sensor unit and the second sensor unit that is to be operated; and allowing the selected sensor unit to detect the light and detecting a touch location.

The third sensor unit may be used to detect the external illumination.

The second sensor unit and the third sensor unit may be simultaneously used to detect the external illumination.

Another aspect of the invention is a touch screen display apparatus comprising: a plurality of light emitting devices disposed on a substrate; at least one first light sensor; at least one second light sensor, wherein the at least one first light sensor is less shielded from the light emitting devices than the at least one second light sensor; and a light detection controller configured to: i) detect the intensity of ambient illumination, ii) selectively operate one of 1) the at least one first light sensor and 2) the at least one second light sensor based at least in part on the detected intensity and iii) detect a touch location based at least in part on light detection by the selected sensor.

In the above apparatus, the light detection controller is further configured to i) select the at least one first light sensor if the detected intensity is less than a predetermined value and ii) select the at least one second light sensor if the detected intensity is greater than the predetermined value. In the above apparatus, the predetermined value is in the range from about 400 lux to about 600 lux. In the above apparatus, the predetermined value is in the range from about 450 lux to about 550 lux.

In the above apparatus, the light detection controller comprises: an ambient illumination detector configured to detect the intensity of the ambient illumination; a sensor selector configured to select one of 1) the at least one first light sensor and 2) the at least one second light sensor based at least in part on the detected intensity; and a touch location detector configured to detect the touch location based at least in part on the detection of the selected sensor. In the above apparatus, the ambient illumination detector is further configured to detect the intensity of the ambient illumination based at least in part on the detection of the at least one second light sensor.

The above apparatus further comprises: at least one third light sensor located in a non-light emitting region, wherein the at least one third light sensor is configured to detect at least part of ambient light incident to the touch screen display apparatus, and wherein the ambient illumination detector is further configured to detect the intensity of the ambient illumination based at least in part on the detection of the at least one third light sensor. In the above apparatus, the ambient illumination detector is further configured to detect the intensity of the ambient illumination based on the detection of i) the at least one second light sensor and ii) the at least one third light sensor.

The above apparatus further comprises a touching screen panel, wherein both of 1) the at least one first light sensor and 2) the at least one second light sensor are farther from the touching screen panel than the light emitting devices. The above apparatus further comprises a touching screen panel, wherein both of 1) the at least one first light sensor and 2) the at least one second light sensor are located at substantially the same distance from the touching screen panel. In the above apparatus, the at least one first sensor and the at least one second sensor are alternately disposed.

In the above apparatus, each of the at least one first sensor and each of the at least one second sensor are connected to a switching transistor. The above apparatus further comprises at least one shading wall formed between the at least one first light sensor and the at least one second light sensor, wherein the at least one shading wall is configured to at least partially block light emitted from the light emitting devices from entering the at least one second light sensor. In the above apparatus, the plurality of light emitting devices are organic light emitting devices (OLEDs).

Another aspect of the invention is a touch screen display apparatus comprising: a plurality of pixels spaced apart from each other, wherein each of the pixels comprises at least one light emitter which is configured to emit light; at least one first light sensor disposed within each of the plurality of pixels, wherein the at least one first light sensor is configured to detect touching of the touch screen display apparatus based at least in part on light emitted from the light emitters; at least one second light sensor disposed between the plurality of pixels, wherein the at least one second light sensor is configured to detect touching of the touch screen display apparatus based at least in part on ambient light incident to the apparatus, and wherein at least part of light emitted from the light emitters is blocked from entering the at least one second light sensor; and a controller configured to: i) determine the intensity of ambient illumination and ii) selectively operate one of 1) the at least one first light sensor and 2) the at least one second light sensor based at least in part on the determined intensity.

In the above apparatus, the controller is further configured to select the at least one first light sensor if the determined intensity is less than a predetermined value and select the at least one second light sensor if the determined intensity is greater than the predetermined value.

Still another aspect of the invention is a method of operating a touch screen display apparatus comprising i) a plurality of light emitters which are configured to emit light, ii) at least one first light sensor and iii) at least one second light sensor, the method comprising: at least partially blocking, via a shading wall, light emitted from the light emitting devices from entering the at least one second light sensor; determining the intensity of ambient illumination; selectively operating one of 1) the at least one first light sensor and 2) at least one second light sensor based at least in part on the determined intensity; and detecting a touch location based at least in part on light detection by the selected sensor.

In the above method, the determining the intensity of ambient illumination is performed based at least in part on the detection of the at least one second light sensor. In the above method, the touch screen display apparatus further comprises at least one third light sensor formed in a non-light emitting region, wherein the at least one third light sensor is configured to detect at least part of ambient light incident to the touch screen display apparatus, and wherein the determining the intensity of ambient illumination is performed based at least in part on the detection of the at least one third light sensor. In the above method, the determining the intensity of ambient illumination is performed based on the detection of 1) the at least one second light sensor and 2) the at least one third light sensor.

### BRIEF DESCRIPTION OF THE DRAWINGS

FIG. 1 is a diagram of a touch screen display apparatus according to an embodiment of the present invention.

FIG. 2 is a block diagram of a light detection controller of the touch screen display apparatus shown in FIG. 1, according to an embodiment of the present invention.

FIG. 3 is a schematic cross-sectional view of the arrangement relationship between a pixel unit and a sensor unit of a touch screen display apparatus according to an embodiment of the present invention.

FIGS. 4 through 6 are schematic diagrams of the arrangement relationship between a first sensor unit and a second sensor unit of the touch screen display apparatus shown in FIG. 1, according to embodiments of the present invention.

FIG. 7 is a schematic cross-sectional view of the arrangement relationship between a pixel unit and a sensor unit of a touch screen display apparatus according to another embodiment of the present invention.

FIG. 8 is a flowchart illustrating a method of operating the touch screen display apparatus, according to an embodiment of the present invention.

### DETAILED DESCRIPTION OF CERTAIN INVENTIVE EMBODIMENTS

A touch screen display device uses various methods of capacitance, a resistance film, an infrared detection, an ultrasonic wave, an integration tension measurement, a piezoelectric effect, light sensing, and the like to recognize a touch.

The light sensing method detects a current generated by a light incident on a light sensor such as photo diode and recognizes a touch. The light sensing method can be used to manufacture a thin film transistor (TFT) array of a flat panel display apparatus such as an active matrix OLED (AMOLED), a TFT-LCD, and the like and simultaneously form a light sensor circuit unit between pixels, thereby providing a thin embedded type touch screen display apparatus.

However, a light sensor formed in the embedded type touch screen display apparatus is influenced by an external light and an internal light (a light emitted from an emitting unit of the touch screen display apparatus) as well, and thus the internal light results in noise of the light sensor. To address this problem, a shading wall is formed around the light sensor so that the light sensor responds only to the external light.

Meanwhile, when a display apparatus is used in a place having a small amount of external light such as at night or dark indoors, it is easier to operate the light sensor by using the internal light. However, the shading wall increases the operability of the light sensor in normal ambient light, whereas the operability of the light sensor is rather reduced in the place having a small amount of external light.

Embodiments of the present invention will now be described more fully with reference to the accompanying drawings, in which exemplary embodiments of the invention are shown.

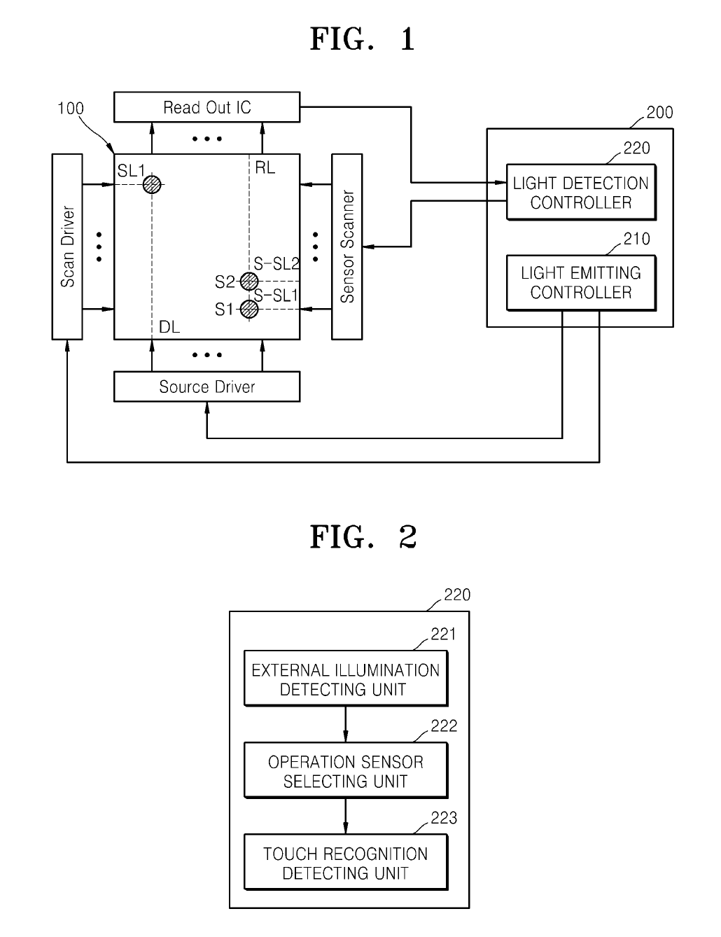

FIG. 1 is a diagram of a touch screen display apparatus according to an embodiment of the present invention. FIG. 2 is a block diagram of a light detection controller of the touch screen display apparatus shown in FIG. 1, according to an embodiment of the present invention.

Referring to FIGS. 1 and 2, the touch screen display apparatus includes a display unit 100 and a controller 200 for operating a pixel unit P and a sensor unit S of the display unit 100.

The display unit 100 includes the pixel unit P and the sensor unit S. The pixel unit P includes an organic light emitting device (not shown). The sensor unit S includes a light sensor (not shown) for detecting a light of a touch object.

The pixel unit P includes a data line DL and a scan line SL1 that crosses the data line DL and transmits a scan signal. The data line DL is connected to a source driver and receives display data. The scan line SL1 receives the scan signal from a scan driver. The display data and the scan signal are provided from a light emitting controller 210 of the controller 200.

Although not shown, the pixel unit P provides a current according to the display data to the organic light emitting device connected to a pixel circuit unit (not shown) and a switching circuit unit (not shown) including a plurality of thin film transistors and capacitors so that the organic light emitting device displays a specific image. The pixel unit P operates under the control of the light emitting controller 210 of the controller 200.

The sensor unit S includes a first sensor unit (or at least one first light sensor) S1 and a second sensor unit (or at least one second light sensor) S2.

The first sensor unit S1 is connected to a first scan line S-SL1 connected to a sensor scanner and receives the scan signal under the control of a light detection controller (or a controller) 220. The first scan line S-SL1 is connected to an output line RL connected to a read out IC (ROIC). The ROIC collects light signals provided from the output lines RL, and transmits the light signals to the light detection controller 220. Therefore, the light detection controller 220 may detect a touch location based on the light signals.

The second sensor unit S2 is connected to a second scan line S-SL2 connected to the sensor scanner and receives the scan signal under the control of the light detection controller 220. The second scan line S-SL2 is connected to the output line RL connected to the ROIC. The ROIC collects the light signals provided from the output lines RL, and transmits the light signals to the light detection controller 220. Therefore, the light detection controller 220 may detect (or determine) external illumination (or ambient illumination) based on the light signals.

The second sensor unit S2 is connected to the second scan line S-SL2 connected to the sensor scanner and receives the scan signal while the first sensor unit S1 does not operate. The second scan line S-SL2 is connected to the output line RL connected to the ROIC. The ROIC collects the light signals provided from the output lines RL, and transmits the light signals to the light detection controller 220. Therefore, the light detection controller 220 may detect the touch location based on the light signals.

The operations of the first sensor unit S1 and the second sensor unit S2 are controlled by the light detection controller 220. Referring to FIG. 2, the light detection controller 220 includes an external illumination detecting unit (or ambient illumination detector) 221, an operation sensor selecting unit 222 (or a sensor selector), and a touch recognition detecting unit (or a touch location detector) 223.

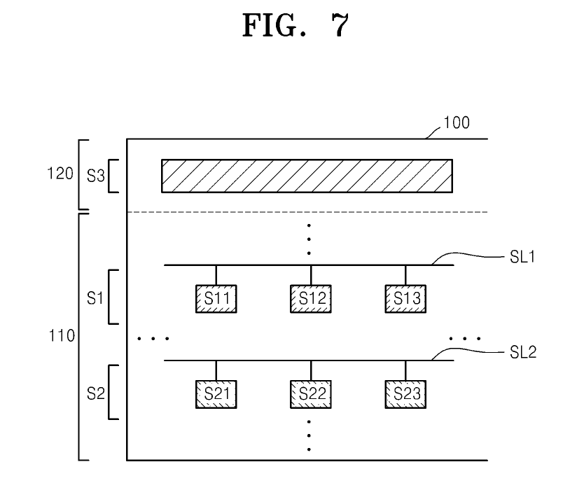

The external illumination detecting unit 221 detects (or determines) the intensity of an external light (or ambient light) in a touch recognition mode of the touch screen display apparatus. In one embodiment, the second sensor unit S2 is used to detect the external illumination. In another embodiment, a separate sensor, alone or in combination with the second sensor unit S2, may be used to detect the external illumination. In one embodiment, the separate sensor may be located on either a light emitting region or a non-light emitting region (see FIG. 7).

When the detected external illumination has a value satisfying a predetermined condition, the operation sensor selecting unit 222 selects one of the first sensor unit S1 and the second sensor unit S2 that is to be operated. For example, if the illumination of the external light is greater than a predetermined illumination threshold (e.g., about 500 lux), the second sensor unit S2 detects a light, and if the illumination of the external light is smaller than the predetermined illumination, the first sensor unit S1 detects the light. Depending on embodiments, the predetermined illumination threshold may have different values, for example, including values less than 500 lux (e.g., between about 400 lux and about 499 lux) or greater than 500 lux (e.g., about 501 lux-about 600 lux). Further, the predetermined illumination threshold value may be in the range of from about 400 lux to about 600 lux, or from about 450 lux to about 550 lux.

The touch recognition detecting unit 223 detects the light by using the selected sensor unit and detects the touch location, so as to input a predetermined command signal to the touch screen display apparatus under the control of the controller 200.

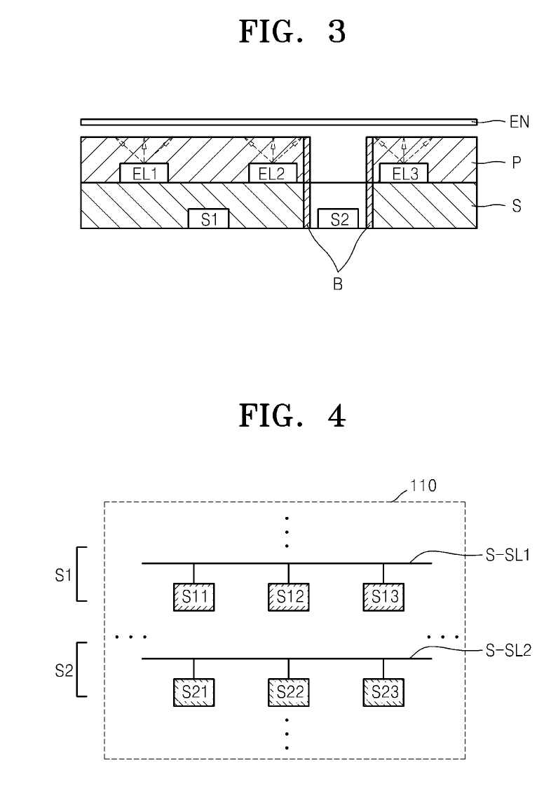

FIG. 3 is a schematic cross-sectional view of the arrangement relationship between the pixel unit P and the sensor unit S of the touch screen display apparatus according to an embodiment of the present invention.

Referring to FIGS. 1 through 3, a plurality of light emitting layers EL1, EL2, and EL3 (or light emitters) of a light emitting device are formed in the pixel unit P with a predetermined gap, and the first sensor unit S1 and the second sensor unit S2 are disposed between the plurality of light emitting layers EL1, EL2, and EL3.

Light sensors, such as light diodes, included in the first sensor unit S1 and the second sensor unit S2 are formed while a thin film transistor (TFT) array substrate of an active matrix organic light emitting display (AMOLED) is manufactured, thereby realizing a thin embedded type touch screen.

The second sensor unit S2 is disposed between pixels and a shading unit (or a shading wall) B is disposed around the second sensor unit S2. In one embodiment, the shading unit B surrounds the side surface of the light sensor included in the second sensor unit S2 so as to at least partially block light emitted from the light emitting layers EL1-EL3 from entering the second sensor unit S2. The shading unit B reduces an influence caused by an internal light emitted from the plurality of light emitting layers EL1, EL2, and EL3 while the second sensor unit S2 detects an external light to recognize a touch, thereby removing noise of the internal light incident in the second sensor unit S2.

The second sensor unit S2 detects external illumination of the touch screen display apparatus under the control of the external illumination detecting unit 221. When the amount (or intensity) of the external light is sufficient as a result of the detection of external illumination, the second sensor unit S2 operates. The touch recognition detecting unit 223 detects the touch location by using information on the light incident to the second sensor unit S2.

The second sensor unit S2 may detect the external illumination by reducing noise caused by the internal light as much as possible when detecting the external illumination. The first sensor unit S1 that detects the internal light may not be used to detect a light so as to detect the touch location, thereby reducing noise caused by the internal light and reducing unnecessary power consumption.

The first sensor unit S1 is disposed between pixels, and detects the light so as to recognize the touch while the second sensor unit S2 does not operate. That is, the first sensor unit S1 operates when the amount of external light is insufficient according to the result of the detection of external illumination. Although the amount of external light is insufficient, if the second sensor unit S2 detects the light so as to recognize the touch, since the shading unit B at least partially or substantially prevents the internal light from reaching the second sensor unit S2, the second sensor unit S2 fails to effectively detect the light.

The first sensor unit S1 may use the internal light so as to recognize the touch when the amount of external light is insufficient. The plurality of light emitting layers EL1, EL2, and EL3 emit light in four directions. If an instruction device, for instructing the touch location, such as a finger or a pen touches a screen of the touch screen display apparatus, such as a sealed substrate EN, the light emitted from the plurality of light emitting layers EL1, EL2, and EL3 is reflected on the instruction device, and the reflected light reaches the operating first sensor unit S1. The touch recognition unit 223 detects the touch location by using a light signal detected by the first sensor unit S1.

FIGS. 4 through 6 are schematic diagrams of the arrangement relationship between the first sensor unit S1 and the second sensor unit S2 of the touch screen display apparatus shown in FIG. 1, according to embodiments of the present invention.

The first sensor unit S1 and the second sensor unit S2 are alternately and uniformly disposed in a light emitting unit 110 of the touch screen display apparatus. The first sensor unit S1 and the second sensor unit S2 receive and transmit independent scan signals.

Referring to FIG. 4, the first sensor unit S1 including a plurality of internal light sensors s11, s12, and s13 and the second sensor unit S2 including a plurality of external light sensors s21, s22, and s23 are connected to separate scan lines S-SL1 and S-SL2, respectively. The first sensor unit S1 and the second sensor unit S2 receive their respective independent scan signals from a sensor scanner. The plurality of internal light sensors s11, s12, and s13 of the first sensor unit S1 and the plurality of external light sensors s21, s22, and s23 of the second sensor unit S2 are substantially aligned in a line, respectively, whereas the first sensor unit S1 and the second sensor unit S2 are alternately and uniformly disposed in the light emitting unit 110.

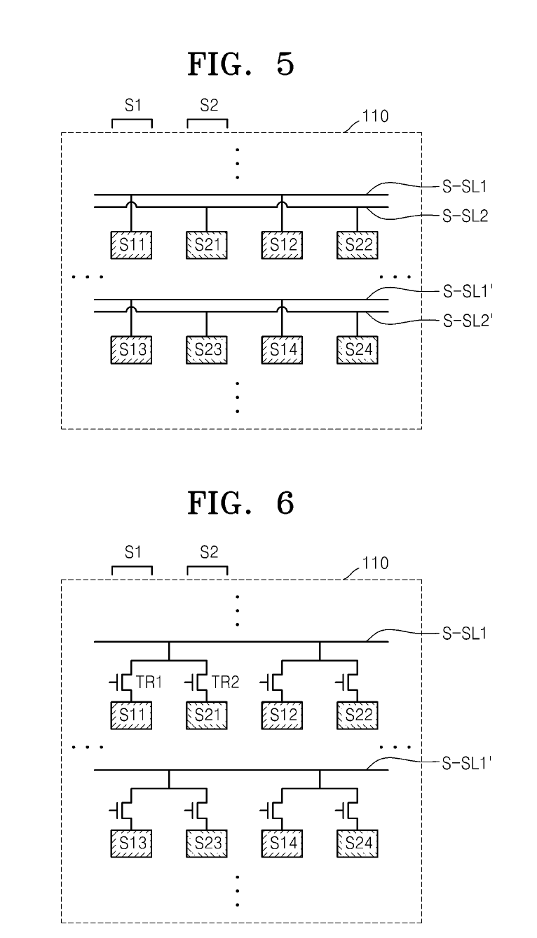

Referring to FIG. 5, a plurality of internal light sensors s11, s12, s13, and s14 and a plurality of external light sensors s21, s22, s23, and s24 are alternately and uniformly disposed in the light emitting unit 110. The internal light sensors s11 and s12, and the external light sensors s21 and s22 are respectively connected to scan lines S-SL1 and S-SL1′, and the internal light sensors s13 and s14, and the external light sensors s23 and s24 are respectively connected to scan lines S-SL2 and S-SL2′, thereby receiving and transmitting independent scan signals from the sensor scanner.

Referring to FIG. 6, although a plurality of internal light sensors s11, s12, s13, and s14 and a plurality of external light sensors s21, s22, s23, and s24 are alternately disposed in the light emitting unit 110, similarly to FIG. 5, the plurality of internal light sensors s11, s12, s13, and s14 and the plurality of external light sensors s21, s22, s23, and s24 are connected to scan lines S-SL1 and S-SL1′. Thus, the first sensor unit S1 and the second sensor unit S2 do not need to have their respective scan lines. In more detail, if independent scan signals are provided to the first sensor unit S1 and the second sensor unit S2, it is unnecessary to physically separate scan lines. As shown in FIG. 6, although the plurality of internal light sensors s11, s12, s13, and s14 and the plurality of external light sensors s21, s22, s23, and s24 share the scan lines S-SL1 and S-SL1′, respectively, since the plurality of internal light sensors s11, s12, s13, and s14 and the plurality of external light sensors s21, s22, s23, and s24 include switch transistors TR1 and TR2, respectively, if the operation sensor selecting unit 222 properly controls the switch transistors TR1 and TR2, the independent scan signals may be applied to the first sensor unit S1 and the second sensor unit S2.

The present invention is not limited to the embodiments shown in FIGS. 4 through 6. That is, various modifications in the locations and the sizes of the first sensor unit S1 and the second sensor unit S2 may be made therein without departing from the spirit and scope of the present invention.

A touch screen display apparatus according to another embodiment of the present invention will now be described with reference to FIG. 7 that is a schematic cross-sectional view of the arrangement relationship between a pixel unit and a sensor unit of the touch screen display apparatus according to another embodiment of the present invention.

Referring to FIG. 7, a display unit 100 of the touch screen display apparatus includes a light emitting unit 110 and a non-light emitting unit 120. The light emitting unit 110 includes a pixel unit (not shown) and first and second sensor units S1 and S2. The non-light emitting unit 120 includes a third sensor unit S3.

The pixel unit P is the same as described with reference to FIG. 1 and thus the description thereof will not repeated.

The three sensor units S1, S2, and S3 are alternately disposed between pixels on the light emitting unit 110 and thus the description thereof will not repeated.

Although the first and second sensor units S1 and S2 are connected to scan lines SL1 and SL2, respectively, as shown in FIG. 4, the present invention is not limited thereto. In more detail, various modifications of the first and second sensor units S1 and S2 may be made if independent scan signals are applied to the first and second sensor units S1 and S2 in the same manner as described with reference to FIG. 4.

The touch screen display apparatus includes the third sensor unit S3 included in the non-light emitting unit 120 and including a plurality of light sensors. Although the third sensor unit S3 is disposed in one side of outside the non-light emitting unit 120, the present invention is not limited thereto, and the plurality of third sensor units S3 may be disposed outside the non-light emitting unit 120.

The third sensor unit S3 detects external illumination of the touch screen display apparatus under the control of the external illumination detecting unit 221. The third sensor unit S3 may detect the external illumination, irrespective of the second sensor unit S2; however, the present invention is not limited thereto, and thus, the third sensor unit S3 and the second sensor unit S2 can detect the external illumination.

As a result of the detection of external illumination, when the intensity of the external light is sufficient, the operation sensor selecting unit 222 operates the second sensor unit S2 in the same manner as described with reference to FIG. 2. The touch recognition detecting unit 223 analyzes a light signal detected by the second sensor unit S2 and detects a touch location.

Meanwhile, according to the result of the detection of external illumination, when the intensity of the external light is insufficient, the operation sensor selecting unit 222 operates the first sensor unit S1. The touch recognition detecting unit 223 analyzes a light signal detected by the first sensor unit S2 and detects a touch location.

In one embodiment, the touch screen display apparatus includes an additional unit, such as the third sensor unit S3, for detecting the external illumination, to thus effectively detect the external illumination.

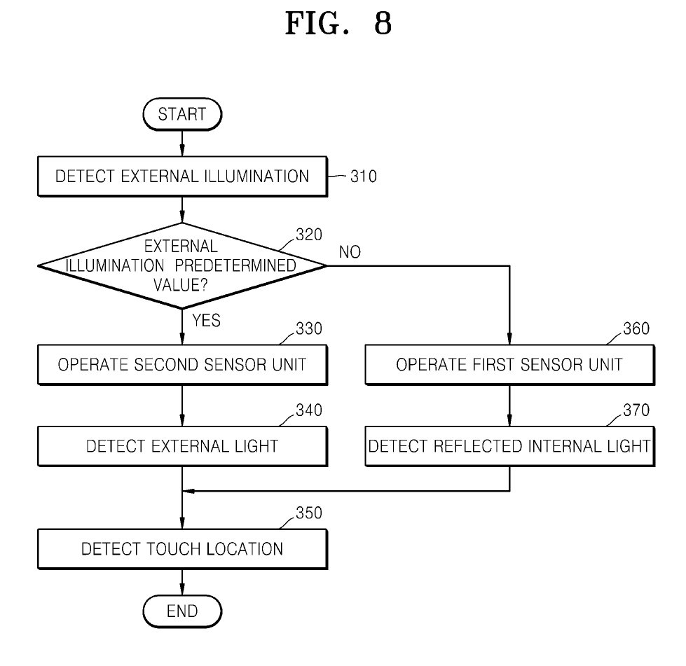

A method of operating the touch screen display apparatus, according to an embodiment of the present invention, will now be described with reference to FIG. 8.

Referring to FIG. 8, the external illumination detecting unit 221 detects external illumination of the touch screen display apparatus (operation 310). When the non-light emitting unit 120 of the touch screen display apparatus includes the third sensor unit S3, the third sensor unit S3 is used to detect the external illumination. When the non-light emitting unit 120 of the touch screen display apparatus does not include the third sensor unit S3, the second sensor unit S2 of the light emitting unit 110 is used to detect the external illumination. Thus the third sensor unit S3 or the second sensor unit S2 may be used to detect the external illumination.

The operation sensor selecting unit 222 determines whether the detected external illumination satisfies a predetermined condition (operation 320). For example, if the detected external illumination is greater than a predetermined value as discussed above, the second sensor unit S2 operates (operation 330). The second sensor unit S2 detects an external light (operation 340), analyzes a detected light signal, and detects a touch location (operation 350). When the amount of external light is sufficient, the second sensor unit S2 that is used to detect the external light detects a light and reduces noise caused by an internal light, thereby effectively recognizing a touch.

Otherwise, if the detected external illumination is smaller than the predetermined value, the first sensor unit S1 operates (operation 360). The first sensor unit S1 detects the internal light emitted from an OLED (operation 370), analyzes a detected light signal, and detects a touch location. When the amount of the external light is insufficient, the second sensor unit S2 included in the shading unit B does not detect the light, thereby effectively increasing touch recognition by using the internal light.

A touch screen display apparatus and a method of operating the same reduce noise caused by an internal light of a light emitting device when a light is detected so as to recognize a touch to thereby effectively increase touch recognition, and process the intensity of an external light by using an algorithm and thus effectively recognize a touch in a bright or dark place. Meanwhile, although a touch screen display apparatus is applied to an OLED, the present invention is not limited thereto. Also, a touch screen display apparatus is applied to an OLED; however, the present invention is not limited thereto, and thus, the touch screen display apparatus can be applied to any display apparatuses including the light emitting device and the OLED.

The algorithm is used to detect external illumination, and thus, noise caused by an internal light may be reduced since an internal light sensor does not operate when the amount of an external light is sufficient, and a light may be efficiently sensed, irrespective of the external light, since an additional internal sensor detects the light when the amount of the external light is insufficient.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A touch screen display apparatus comprising:
a plurality of light emitting devices disposed on a substrate;
at least one first light sensor;
at least one second light sensor, wherein the at least one first light sensor is less shielded from the light emitting devices than the at least one second light sensor; and
a light detection controller configured to: i) detect the intensity of ambient illumination, ii) selectively operate one of 1) the at least one first light sensor and 2) the at least one second light sensor based at least in part on the detected intensity and iii) detect a touch location based at least in part on light detection by the selected sensor.

2. The touch screen display apparatus of claim 1, wherein the light detection controller is further configured to i) select the at least one first light sensor if the detected intensity is less than a predetermined value and ii) select the at least one second light sensor if the detected intensity is greater than the predetermined value.

3. The touch screen display apparatus of claim 2, wherein the predetermined value is in the range from about 400 lux to about 600 lux.

4. The touch screen display apparatus of claim 2, wherein the predetermined value is in the range from about 450 lux to about 550 lux.

5. The touch screen display apparatus of claim 1, wherein the light detection controller comprises:
an ambient illumination detector configured to detect the intensity of the ambient illumination;
a sensor selector configured to select one of 1) the at least one first light sensor and 2) the at least one second light sensor based at least in part on the detected intensity; and
a touch location detector configured to detect the touch location based at least in part on the detection of the selected sensor.

6. The touch screen display apparatus of claim 5, wherein the ambient illumination detector is further configured to detect the intensity of the ambient illumination based at least in part on the detection of the at least one second light sensor.

7. The touch screen display apparatus of claim 5, further comprising: at least one third light sensor located in a non-light emitting region, wherein the at least one third light sensor is configured to detect at least part of ambient light incident to the touch screen display apparatus, and wherein the ambient illumination detector is further configured to detect the intensity of the ambient illumination based at least in part on the detection of the at least one third light sensor.

8. The touch screen display apparatus of claim 7, wherein the ambient illumination detector is further configured to detect the intensity of the ambient illumination based on the detection of i) the at least one second light sensor and ii) the at least one third light sensor.

9. The touch screen display apparatus of claim 1, further comprising a touching screen panel, wherein both of 1) the at least one first light sensor and 2) the at least one second light sensor are farther from the touching screen panel than the light emitting devices.

10. The touch screen display apparatus of claim 1, further comprising a touching screen panel, wherein both of 1) the at least one first light sensor and 2) the at least one second light sensor are located at substantially the same distance from the touching screen panel.

11. The touch screen display apparatus of claim 1, wherein the at least one first sensor and the at least one second sensor are alternately disposed.

12. The touch screen display apparatus of claim 11, wherein each of the at least one first sensor and each of the at least one second sensor are connected to a switching transistor.

13. The touch screen display apparatus of claim 1, further comprising at least one shading wall formed between the at least one first light sensor and the at least one second light sensor, wherein the at least one shading wall is configured to at least partially block light emitted from the light emitting devices from entering the at least one second light sensor.

14. The touch screen display apparatus of claim 1, wherein the plurality of light emitting devices are organic light emitting devices (OLEDs).

15. A touch screen display apparatus comprising:
a plurality of pixels spaced apart from each other, wherein each of the pixels comprises at least one light emitter which is configured to emit light;
at least one first light sensor disposed within each of the plurality of pixels, wherein the at least one first light sensor is configured to detect touching of the touch screen display apparatus based at least in part on light emitted from the light emitters;
at least one second light sensor disposed between the plurality of pixels, wherein the at least one second light sensor is configured to detect touching of the touch screen display apparatus based at least in part on ambient light incident to the apparatus, and wherein at least part of light emitted from the light emitters is blocked from entering the at least one second light sensor; and
a controller configured to: i) determine the intensity of ambient illumination and ii) selectively operate one of 1) the at least one first light sensor and 2) the at least one second light sensor based at least in part on the determined intensity.

16. The touch screen display apparatus of claim 15, wherein the controller is further configured to select the at least one first light sensor if the determined intensity is less than a predetermined value and select the at least one second light sensor if the determined intensity is greater than the predetermined value.

17. A method of operating a touch screen display apparatus comprising i) a plurality of light emitters which are configured to emit light, ii) at least one first light sensor and iii) at least one second light sensor, the method comprising:
at least partially blocking, via a shading wall, light emitted from the light emitting devices from entering the at least one second light sensor;
determining the intensity of ambient illumination;
selectively operating one of 1) the at least one first light sensor and 2) at least one second light sensor based at least in part on the determined intensity; and
detecting a touch location based at least in part on light detection by the selected sensor.

18. The method of claim 17, wherein the determining the intensity of ambient illumination is performed based at least in part on the detection of the at least one second light sensor.

19. The method of claim 17, wherein the touch screen display apparatus further comprises at least one third light sensor formed in a non-light emitting region, wherein the at least one third light sensor is configured to detect at least part of ambient light incident to the touch screen display apparatus, and wherein the determining the intensity of ambient illumination is performed based at least in part on the detection of the at least one third light sensor.

20. The method of claim 19, wherein the determining the intensity of ambient illumination is performed based on the detection of 1) the at least one second light sensor and 2) the at least one third light sensor.
